(19) United States
(12) Patent Application Publication
(10) Pub. No.: US 2009/0098264 A1
(43) Pub. Date: Apr. 16, 2009

(54) Method for Roasting Coffee Beans

(76) Inventor: Maria Krebs, Dusseldorf (DE)

Correspondence Address: GUDRUN E. HUCKETT DRAUDT, SCHUBERTSTR. 15A, WUPPERTAL, 42289, DE

(21) Appl. No.: 12/248,991

(22) Filed: Oct. 10, 2008

(30) Foreign Application Priority Data
Oct. 11, 2007 (DE) 10 2007 049 090.0

(51) Int. Cl. A23F 5/04

(52) U.S. Cl. 426/466

(57) ABSTRACT

In a method for roasting coffee beans, in a first stage the coffee beans are roasted for 4 to 6 minutes at a temperature of about 205° C. for removing residual moisture and subsequently the coffee beans are cooled with an air mist spray at approximately 10° C to 15° C. for a time period of 4 to 7 minutes. In a subsequent second stage the coffee beans are roasted further at a temperature of approximately 205° C and cooled again as described in the previous stage. In a subsequent third stage the coffee beans are roasted further for approximately 8 to 20 minutes at a temperature of 200 to 235° C. and subsequently cooled again.

In known methods for roasting coffee the raw coffee beans are stirred in a rotatable drum for approximately 15 to 30 minutes wherein the atmosphere in which the coffee is being moved is maintained at a temperature in the range of approximately 216° C. For a gentle treatment of the coffee beans a roasting time as long as possible is desired provided that the coffee in this time is thoroughly and satisfactorily roasted. Too high temperatures are to be avoided in general because they entail the risk that the coffee burns during roasting while for a shorter roasting time without a corresponding increase of roasting temperature a satisfactory coffee roasting cannot be obtained.

The invention has the object to provide a gentle roasting method for a coffee bean wherein in particular it is desired to obtain a coffee with a low caffeine contents and minimal proportion of tannins and bitter compounds.

As a solution to this object in accordance with the present invention a method for roasting coffee beans is proposed that is characterized in that the raw beans
in a first stage are roasted for approximately 4 to 6 minutes, preferably approximately in the range of approximately 5 minutes, at a temperature in the range of approximately 205° C. for removing the residual moisture and subsequently cooled in an air mist spray (water vapor) at approximately 10° C. to 15° C., preferably 12° C., for a time period of 4 to 7 minutes, preferably approximately 5 minutes, and the beans treated in this way
in a second stage are roasted further at a temperature in the range of approximately 205° C. for 4 to 6 minutes and are again cooled as described in stage 1 above

and subsequently
in a third stage are roasted again for approximately 8 to 20 minutes, preferably in the range of 9 to 14 minutes at a temperature in the range of approximately 230° C. and subsequently cooled again in that cooled and air-conditioned dry air (12° C.) is caused to act on the beans approximately 10 minutes before further processing.

According to a preferred procedure, it is proposed that the roasting processes of the three stages are carried out within a rotating, in particular gas-heated, roasting drum and the beans, for the purpose of cooling, are removed from the roasting drum in the first and second stages and fed into a cooling bed or collecting container. The cooling action is carried out by means of a mechanical atomizer that moistens like an air mist the beans circulating in the cooling bed or the collecting container without significantly wetting the beans.

What is claimed is:

1-5. (canceled)

6. A method for roasting coffee beans comprising:
a) roasting in a first stage the coffee beans for approximately 4 to 6 minutes at a temperature of approximately 205° C. for removing residual moisture and subsequently cooling the coffee beans with an air mist spray at approximately 10° C. to 15° C. for a time period of 4 to 7 minutes;
b) roasting in a subsequent second stage the coffee beans further at a temperature of approximately 205° C. and cooling the coffee beans again as described in the step a);
c) roasting in a subsequent third stage the coffee beans further for approximately 8 to 20 minutes at a temperature in a range of approximately 200 to 235° C. and subsequently cooling the coffee beans again.

7. The method according to claim 6, wherein in the step a) the coffee beans are roasted approximately for 5 minutes at approximately 205° C. and subsequently the coffee beans are cooled with an air mist spray at approximately 12° C. for a time period of approximately 5 minutes.

8. The method according to claim 6, wherein in the step c) the coffee beans are roasted in the range of 9 to 14 minutes and in a range of approximately 210 to 230° C.

9. The method according to claim 6, wherein roasting in the steps a), b) and c) is carried out in a rotating and gas-heated roasting drum and the coffee beans are removed from the roasting drum in the steps a) and b) for cooling and fed to a cooling bed.

10. The method according to claim 6, wherein the coffee carry out a circulating movement beans for cooling in the step a) and the step b).

11. The method according to 6, wherein cooling in the steps a) and b) is done by a mechanical atomizer generating an air mist to moisten the coffee beans in a cooling bed or a collecting container without wetting the coffee beans significantly.

12. The method according to claim 6, wherein in the step c) cooled and air-conditioned dry air at a temperature of approximately 12° C. is applied to the coffee beans for approximately 8 to 12 minutes.

13. The method according to claim 12, wherein the cooled and air-conditioned dry air is applied for approximately 10 minutes.
